(19) United States
(12) Patent Application Publication
(10) Pub. No.: US 2018/0349346 A1
(43) Pub. Date: Dec. 6, 2018

(54) LATTICE-BASED TECHNIQUES FOR PROVIDING SPELLING CORRECTIONS

(71) Applicant: Apple Inc., Cupertino, CA (US)

(72) Inventors: Jun HATORI, Santa Clara, CA (US); Xin WANG, San Jose, CA (US); Junki MARUI, Santa Clara, CA (US); Zengjia YAN, San Jose, CA (US)

(21) Appl. No.: 15/693,199

(22) Filed: Aug. 31, 2017

Related U.S. Application Data
(60) Provisional application No. 62/514,632, filed on Jun. 2, 2017.

(51) Int. Cl. G06F 17/27; G06F 3/0482; G06F 3/0488

(52) U.S. Cl. CPC G06F 17/273; G06F 3/04886; G06F 3/0482

(57) ABSTRACT

Systems and processes for providing spelling corrections are provided. In accordance with one example, a method includes, at an electronic device with one or more processors and memory: receiving a user input; obtaining a text string corresponding to a first symbolic system of a language; determining, based on the text string, a plurality of character segments, which includes a first character segment and a second character segment both corresponding to a same portion of the text string. At least one of the first character segment and the second character segment is a modified version of the portion of the text string. The method further includes determining, based on the plurality of character segments, a plurality of sequences of candidate words in a second symbolic system of the language; identifying a sequence of the plurality of sequences of candidate words; and displaying the sequence of candidate words for user selection.

This application claims priority to U.S. provisional patent application 62/514,632 entitled “LATTICE-BASED TECHNIQUES FOR PROVIDING SPELLING CORRECTIONS”, filed on Jun. 2, 2017, the content of which is hereby incorporated by reference in its entirety.

### FIELD

This relates generally to language input and, more specifically, to techniques for providing spelling corrections.

### BACKGROUND

For many languages such as Chinese and Japanese, text can be phonetically entered in a first symbolic system and converted for display in a second symbolic system. For example, Pinyin is a phonetic system for transcribing Mandarin Chinese using the Roman alphabet. In a Pinyin transliteration, the phonetic pronunciations of Chinese characters can be mapped to syllables composed of Roman letters. As another example, Romaji is a phonetic system for transcribing Japanese using the Roman alphabet. For a given input in the first symbolic system (e.g., Pinyin, Romaji), the system outputs one or more words or phrases corresponding to the input in the second symbolic system (e.g., Chinese characters, Japanese Hiragana characters).

When providing a textual input (e.g., via a keyboard), a user can make one or more mistakes. Exemplary errors include substitution errors (e.g., the user entered the wrong character), deletion errors (e.g., the user missed entering a character), insertion errors (i.e., the user entered an extra character), and transposition errors (e.g., the user entered two characters in the wrong order). Because a variety of errors can be introduced in any portion of the textual input, comparing the textual input with a finite number of common error patterns does not capture all of the errors, and thus does not allow the electronic device to provide optimal spelling corrections. As a result, the user needs to provide additional input and expend additional time to obtain the desired word(s). This can cause frustration and negatively impact user experience.

### SUMMARY

Example methods are disclosed herein. An example method includes, at an electronic device having one or more processors and memory, receiving a user input; obtaining, based on the user input, a text string corresponding to a first symbolic system of a language; determining, based on the text string, a plurality of character segments, where a first character segment and a second character segment of the plurality of character segments correspond to a same portion of the text string; and where at least one of the first character segment and the second character segment is a modified version of the portion of the text string. The method further includes determining, based on the plurality of character segments, a plurality of sequences of candidate words in a second symbolic system of the language. The plurality of sequences of candidate words comprises a first sequence of candidate words based on the first character segment and a second sequence of candidate words based on the second character segment. The method further includes identifying a sequence of the plurality of sequences of candidate words; and displaying the identified sequence of candidate words for user selection.

Example non-transitory computer-readable media are disclosed herein. An example non-transitory computer-readable storage medium stores one or more programs. The one or more programs comprise instructions, which when executed by one or more processors of an electronic device, cause the electronic device to receive a user input; obtain, based on the user input, a text string corresponding to a first symbolic system of a language; determine, based on the text string, a plurality of character segments, where a first character segment and a second character segment of the plurality of character segments correspond to a same portion of the text string; and where at least one of the first character segment and the second character segment is a modified version of the portion of the text string. The one or more programs further comprise instructions that cause the electronic device to determine, based on the plurality of character segments, a plurality of sequences of candidate words in a second symbolic system of the language, where the plurality of sequences of candidate words comprises a first sequence of candidate words based on the first character segment and a second sequence of candidate words based on the second character segment; identify a sequence of the plurality of sequences of candidate words; and display the identified sequence of candidate words for user selection.

Example electronic devices are disclosed herein. An example electronic device comprises one or more processors; a memory; and one or more programs, where the one or more programs are stored in the memory and configured to be executed by the one or more processors, the one or more programs including instructions for receiving a user input; obtaining, based on the user input, a text string corresponding to a first symbolic system of a language; determining, based on the text string, a plurality of character segments, where a first character segment and a second character segment of the plurality of character segments correspond to a same portion of the text string; and where at least one of the first character segment and the second character segment is a modified version of the portion of the text string. The one or more programs further include instructions for determining, based on the plurality of character segments, a plurality of sequences of candidate words in a second symbolic system of the language, where the plurality of sequences of candidate words comprises a first sequence of candidate words based on the first character segment and a second sequence of candidate words based on the second character segment; identifying a sequence of the plurality of sequences of candidate words; and displaying the identified sequence of candidate words for user selection.

An example electronic device comprises means for receiving a user input; means for obtaining, based on the user input, a text string corresponding to a first symbolic system of a language; means for determining, based on the text string, a plurality of character segments, where a first character segment and a second character segment of the plurality of character segments correspond to a same portion of the text string; and where at least one of the first character segment and the second character segment is a modified version of the portion of the text string. The electronic device further comprises means for determining, based on the plurality of character segments, a plurality of sequences of candidate words in a second symbolic system of the language, where the plurality of sequences of candidate words comprises a first sequence of candidate words based on the first character segment and a second sequence of candidate words based on the second character segment; means for identifying a sequence of the plurality of sequences of candidate words; and means for displaying the identified sequence of candidate words for user selection.

Determining, based on an inputted text string, a plurality of character segments with at least two of the character segments corresponding to a same portion of the text string allows an electronic device to obtain a lattice of character segments. In particular, some of the character segments in the lattice correspond to autocorrected (i.e., modified) portions of the text string. As such, the lattice of character segments represents a comprehensive set of candidate text strings that have been autocorrected. The comprehensive set of autocorrected text strings results in a comprehensive set of autocorrected words, a comprehensive set of autocorrected phrases, and/or a comprehensive set of autocorrected sentences, thus allowing the electronic device to correct a large number of errors. For example, the lattice-based techniques allow the electronic device to correct multiple errors even if all of the errors are located close to each other in the text string (e.g., adjacent to each other). Providing optimal spelling corrections efficiently allows the electronic device to provide a fast and accurate input mechanism, thus reducing the number of user corrections. Reducing the number of user inputs and reducing the cognitive burden on the user enhance the operability of the devices and make the user-device interfaces more efficient (e.g., by improving interpretation of user requests, by reducing repetitive user inputs) which, additionally, reduces power usage and improves battery life of the devices by enabling the user to use the devices more quickly and efficiently.

Identifying a set of character segments (e.g., based on language rules) and identifying a subset of the set of character segments (e.g., based on confidence scores) for further processing (e.g., for constructing a word lattice) allow the electronic device to efficiently process a comprehensive set of spelling corrections. Providing optimal spelling corrections efficiently allows the electronic device to provide a fast and accurate input mechanism, thus reducing the number of user corrections. Reducing the number of user inputs and reducing the cognitive burden on the user enhance the operability of the devices and make the user-device interfaces more efficient (e.g., by improving interpretation of user requests, by reducing repetitive user inputs) which, additionally, reduces power usage and improves battery life of the devices by enabling the user to use the devices more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4 is a block diagram of an exemplary multifunction device with a display and a touch-sensitive surface, according to various examples.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7 illustrates a process for providing spelling corrections, according to various examples.

FIG. 8 illustrates an exemplary block diagram of a language input module in accordance with some embodiments.

FIGS. 9A-9B illustrate an autocorrected sequence of Japanese words converted from a Japanese Romaji text input in accordance with some embodiments.

FIG. 10 illustrates an electronic device implementing aspects of lattice-based techniques for providing spelling corrections, according to various examples.

FIG. 11 illustrates an electronic device implementing aspects of lattice-based techniques for providing spelling corrections, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

As discussed, when providing a textual input (e.g., via a keyboard), the user can make one or more mistakes. Examples of the present invention are directed to lattice-based techniques for providing spelling corrections. Such techniques allow the electronic device to provide a fast and accurate input mechanism, thus reducing the number of user corrections. Reducing the number of user inputs and reducing the cognitive burden on the user enhance the operability of the devices and make the user-device interfaces more efficient (e.g., by improving interpretation of user requests, by reducing repetitive user inputs) which, additionally, reduces power usage and improves battery life of the devices by enabling the user to use the devices more quickly and efficiently.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

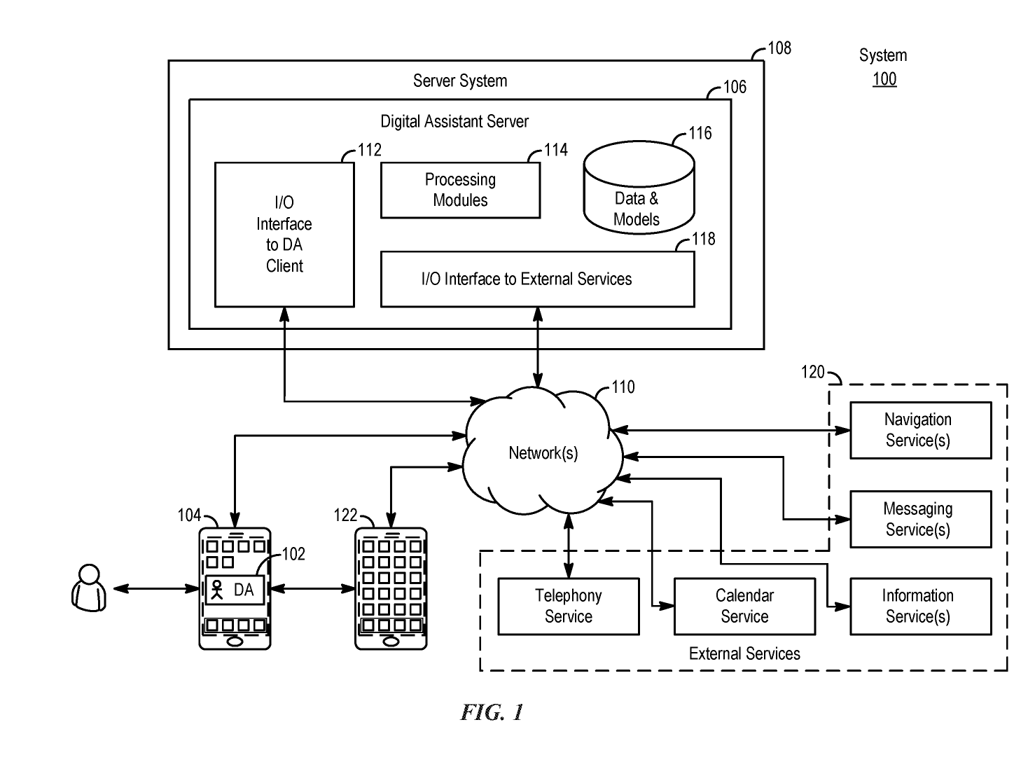

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

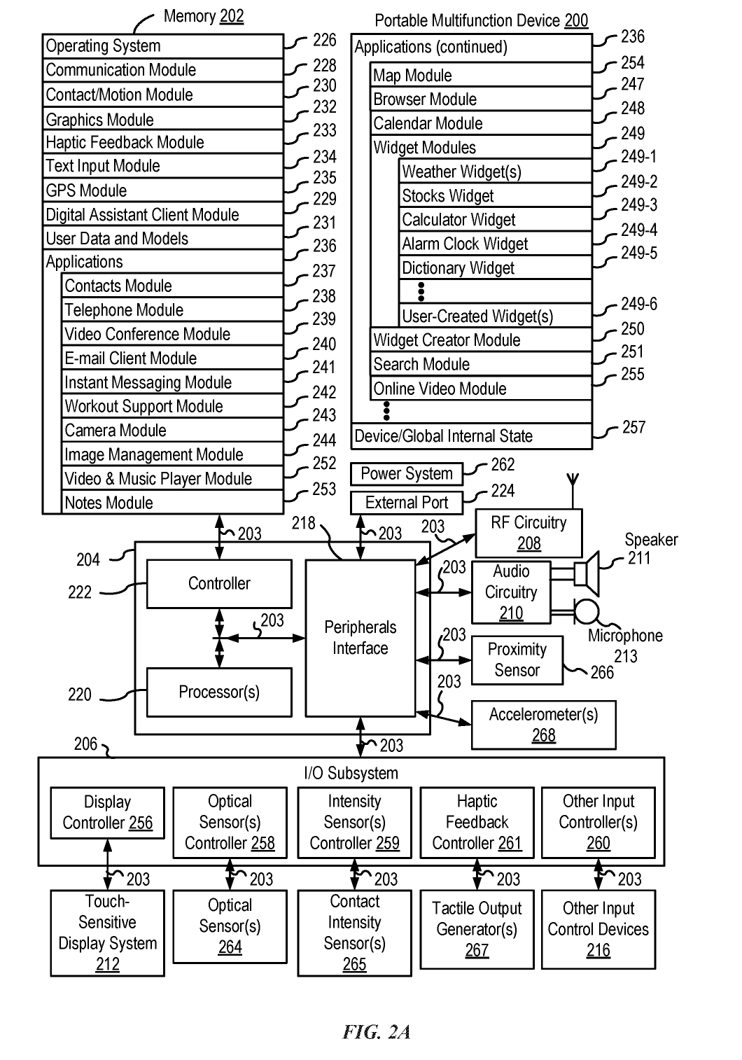

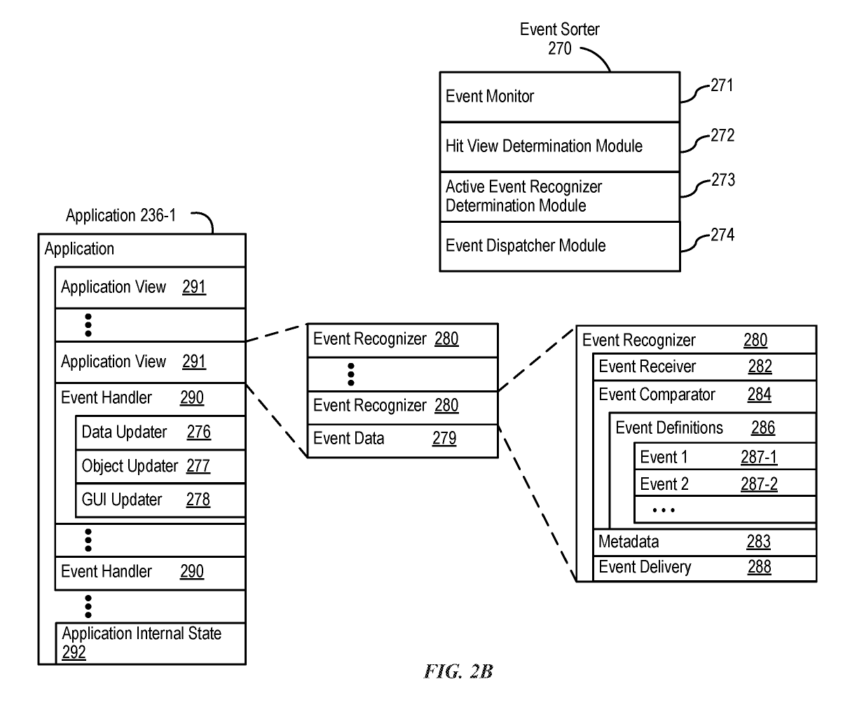

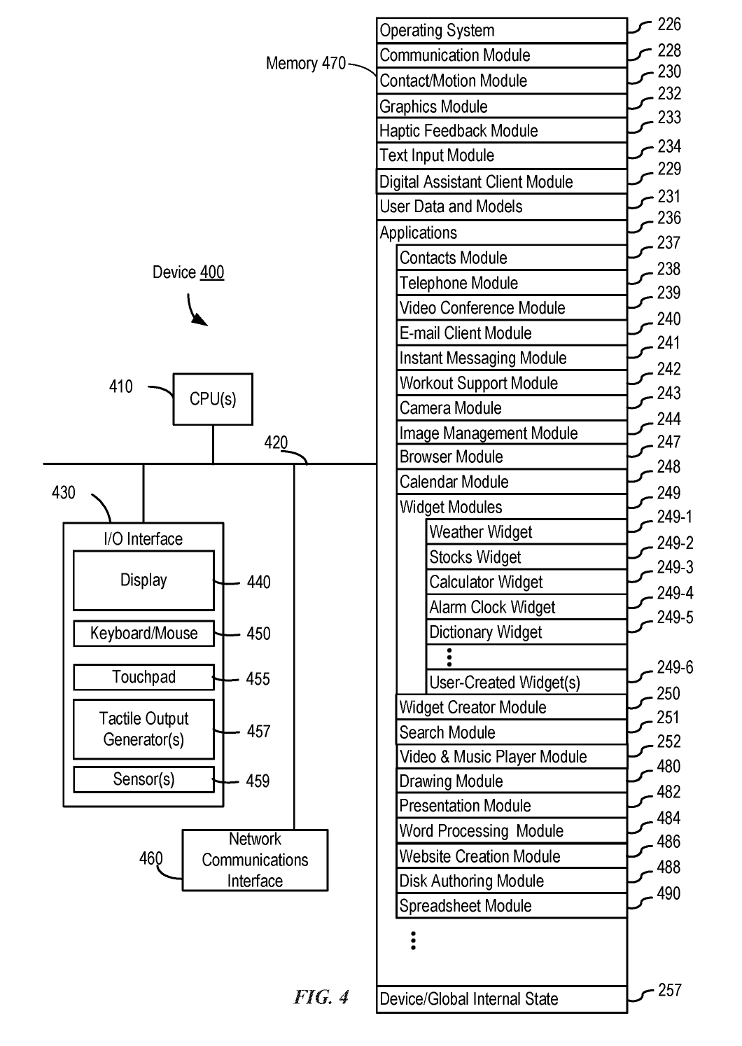

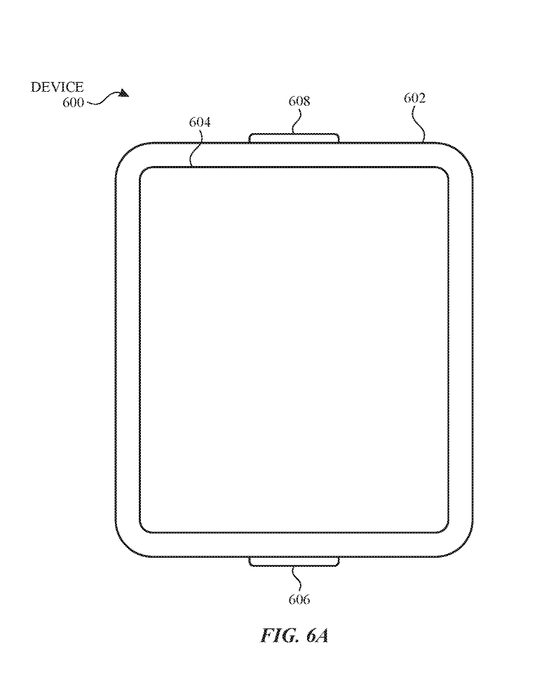

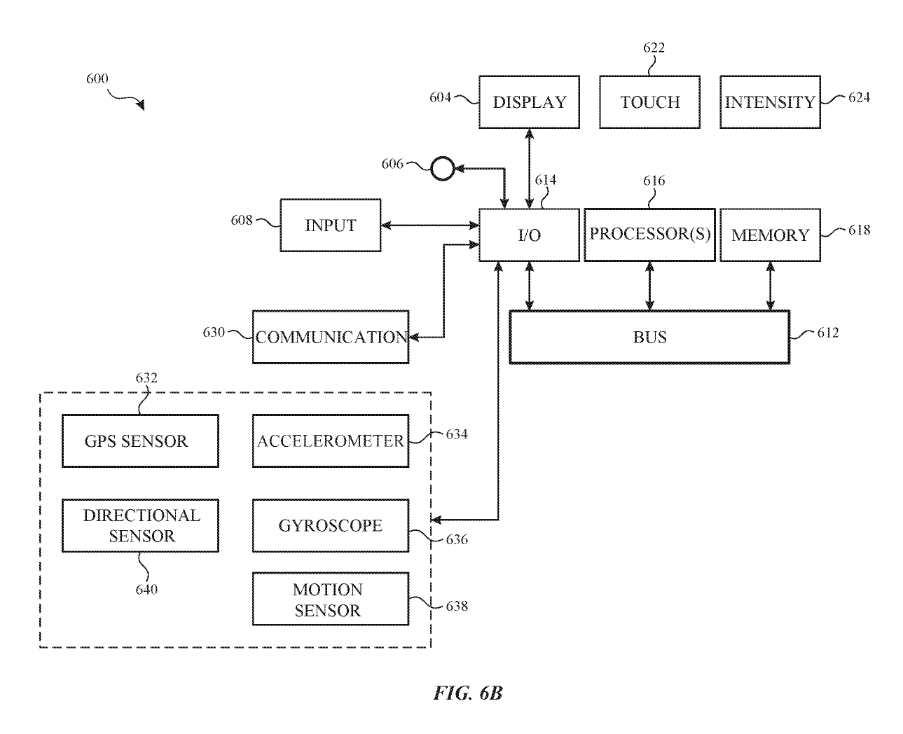

User device 104 can be any suitable electronic device. In some examples, user device is a portable multifunctional device (e.g., device 200, described below with reference to FIG. 2A), a multifunctional device (e.g., device 400, described below with reference to FIG. 4), or a personal electronic device (e.g., device 600, described below with reference to FIG. 6A-6B.) A portable multifunctional device is, for example, a mobile telephone that also contains other functions, such as PDA and/or music player functions. Specific examples of portable multifunction devices include the iPhone®, iPod Touch®, and iPad® devices from Apple Inc. of Cupertino, Calif. Other examples of portable multifunction devices include, without limitation, laptop or tablet computers. Further, in some examples, user device 104 is a non-portable multifunctional device. In particular, user device 104 is a desktop computer, a game console, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoW), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and return relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoW), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

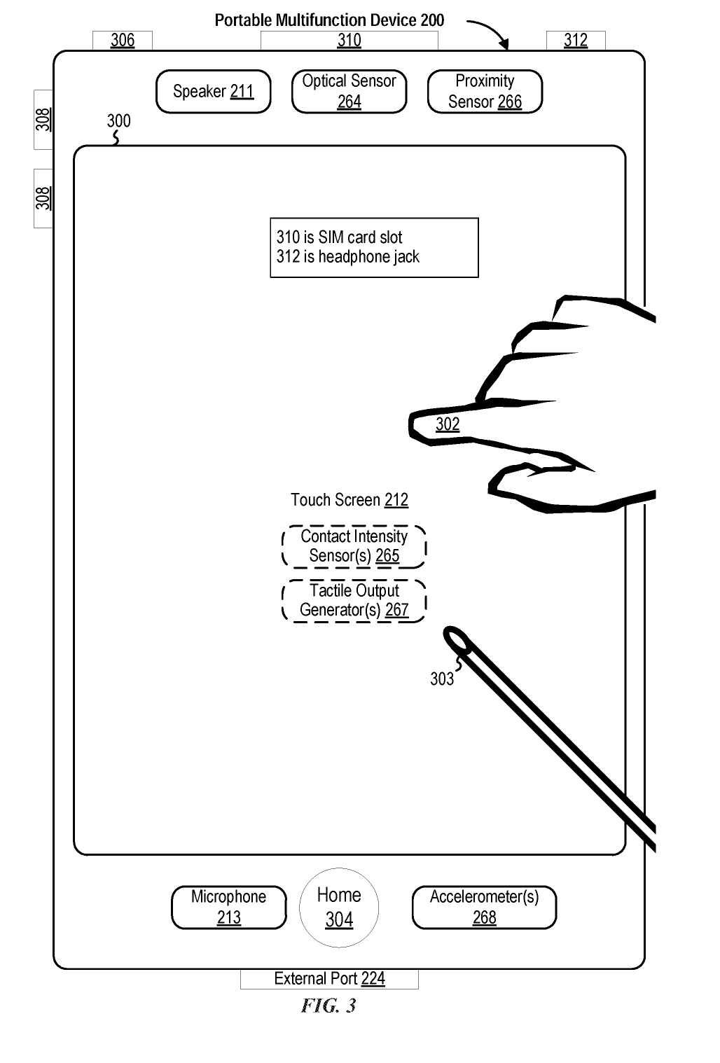

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, Calif.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts 237, email 240, IM 241, browser 247, and any other application that needs text input).

GPS module 235 determines the location of the device and provides this information for use in various applications (e.g., to telephone 238 for use in location-based dialing; to camera 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 229, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

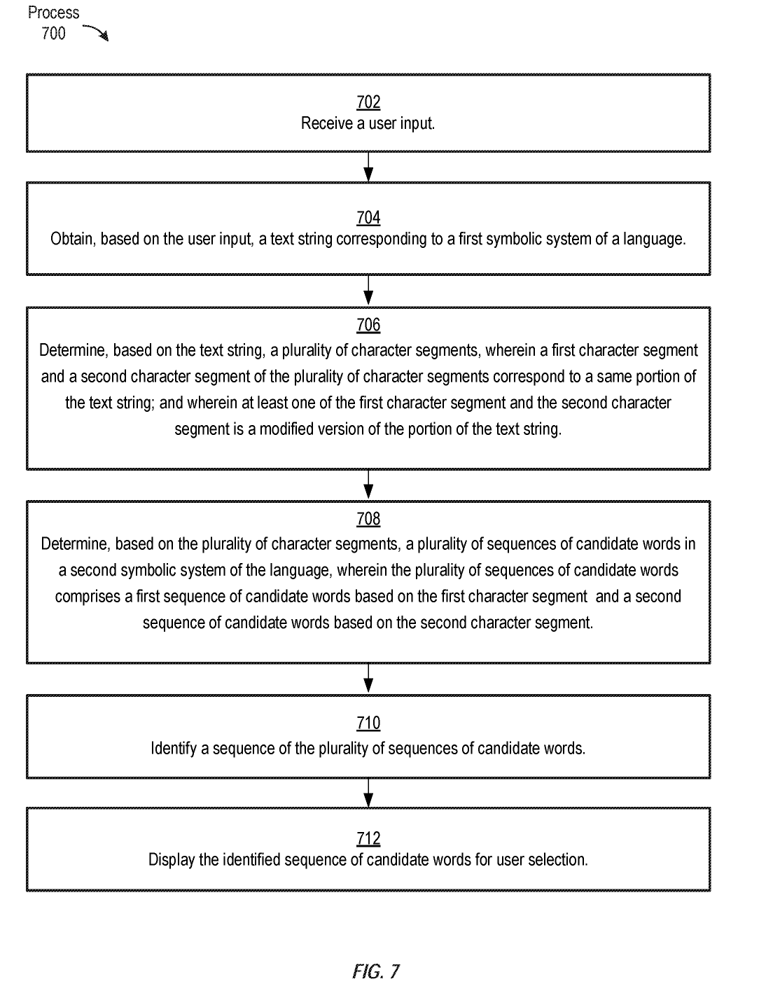

A more detailed description of a digital assistant is described below with reference to FIG. 7. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference module 239, e-mail 240, or IM 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4 is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4 is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Attention is now directed towards embodiments of user interfaces that can be implemented on, for example, portable multifunction device 200.

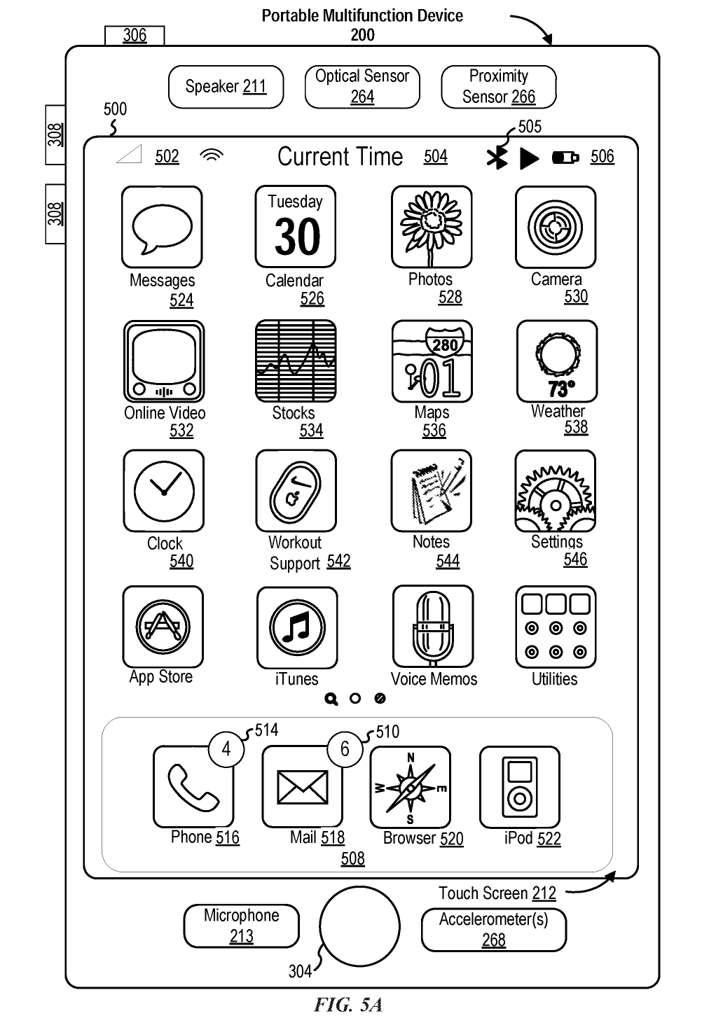

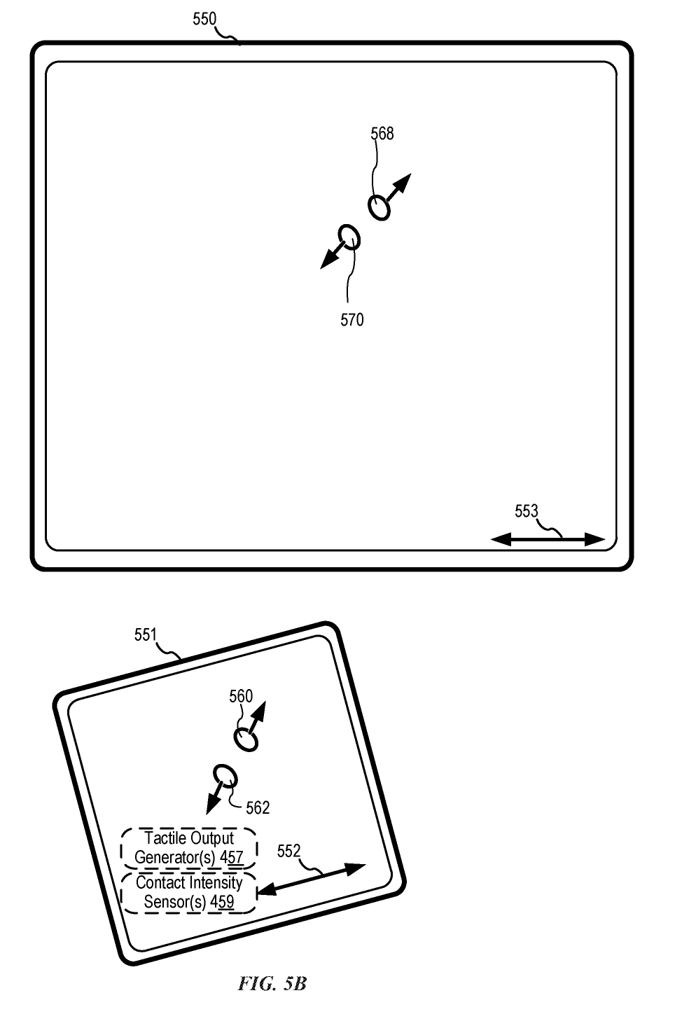

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4) with a touch-sensitive surface 551 (e.g., a tablet or touchpad 455, FIG. 4) that is separate from the display 550 (e.g., touch screen display 212). Device 400 also, optionally, includes one or more contact intensity sensors (e.g., one or more of sensors 457) for detecting intensity of contacts on touch-sensitive surface 551 and/or one or more tactile output generators 459 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, 1000, and/or 1100 (FIGS. 2, 4, 6, 10, and 11). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4 or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Lattice-Based Techniques for Providing Spelling Corrections

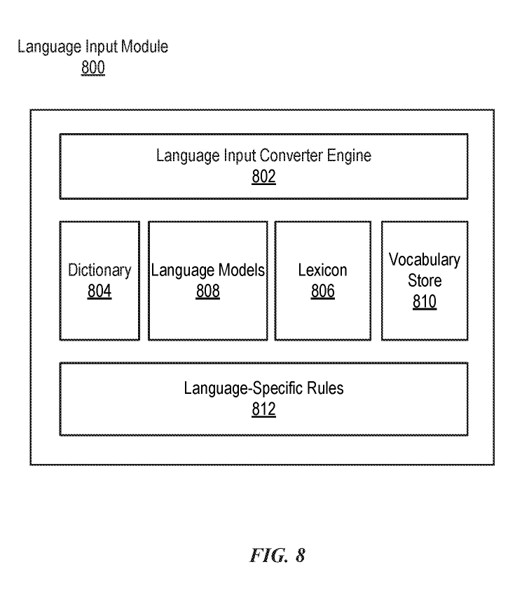

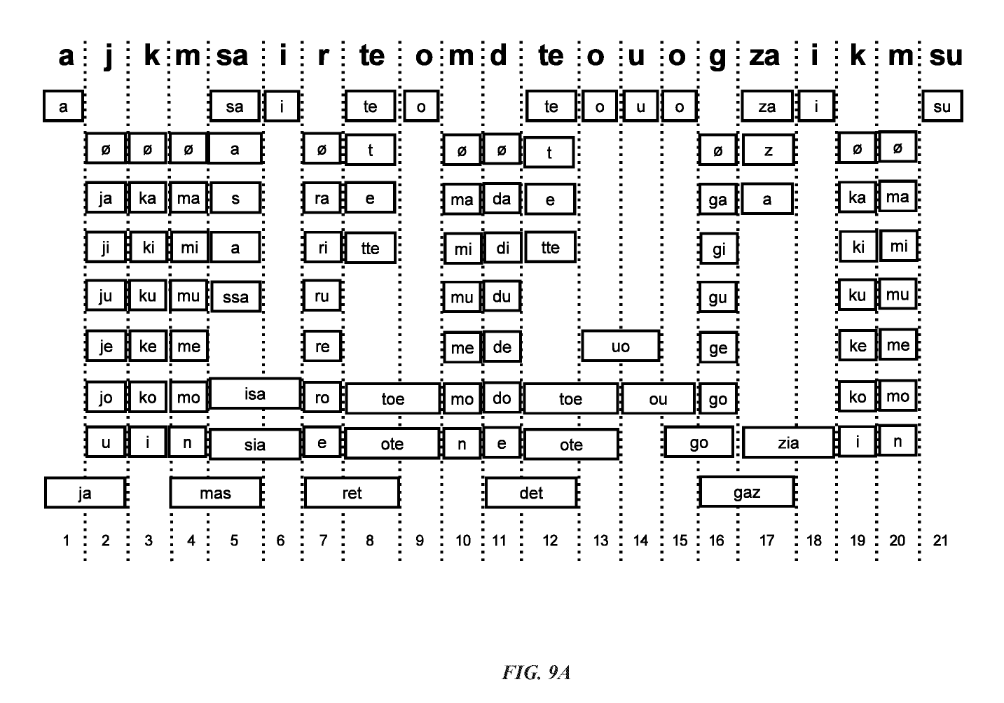

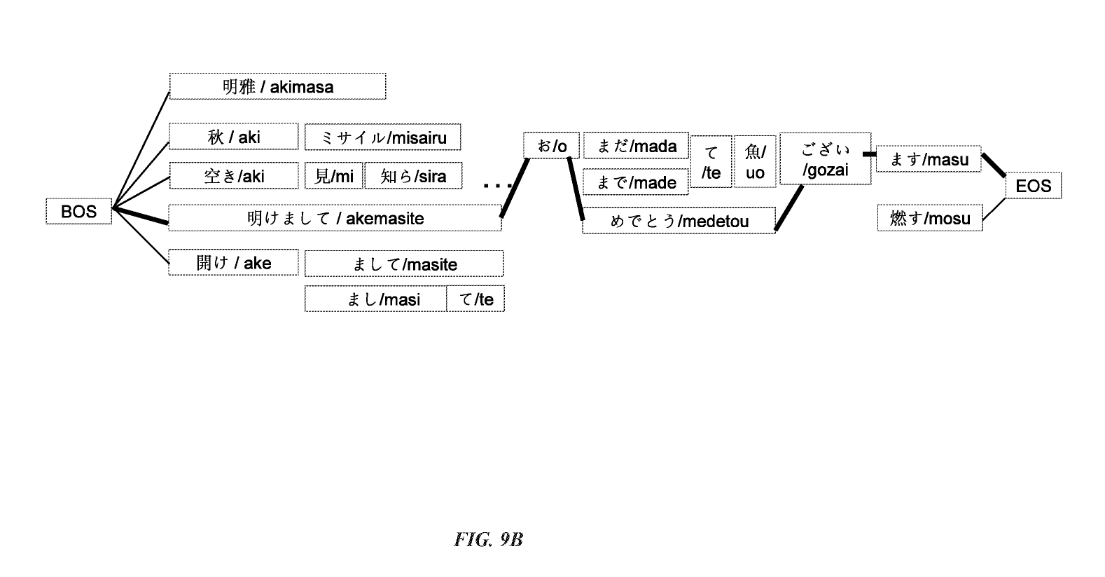

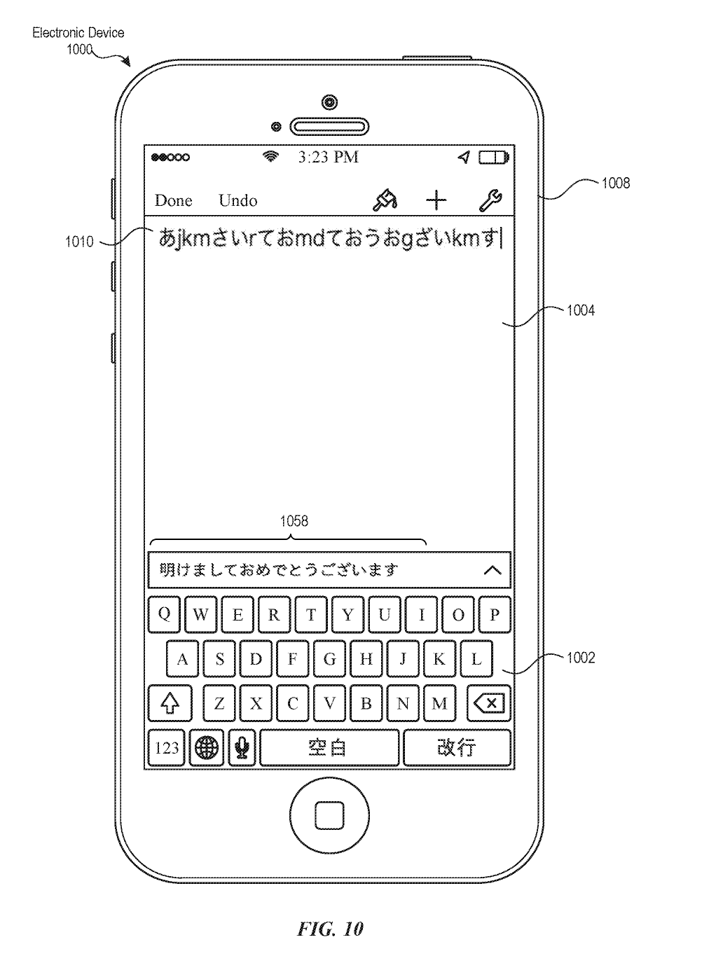

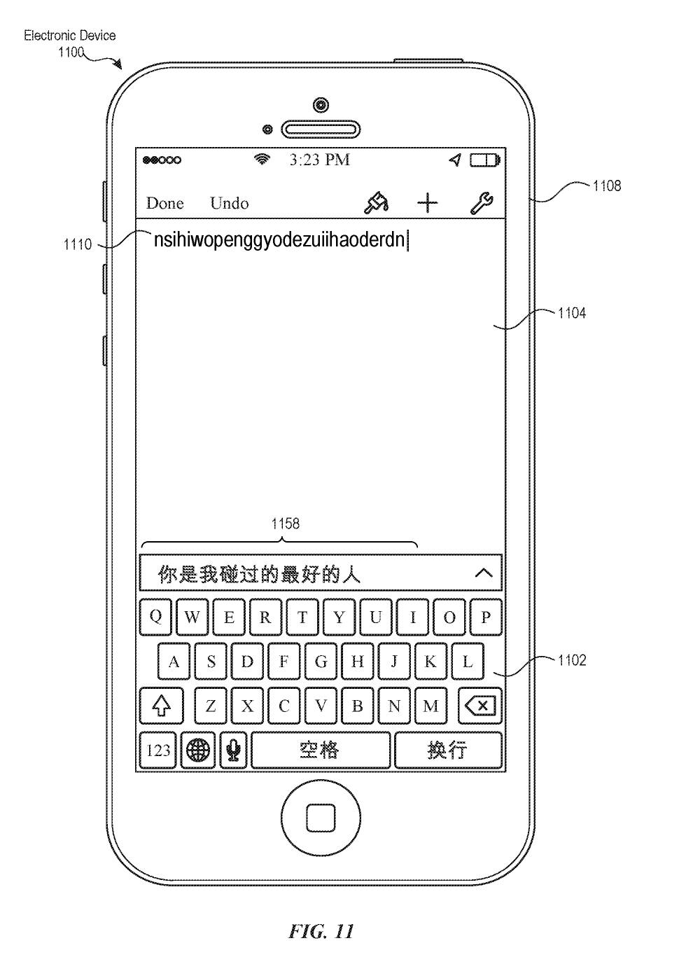

FIG. 7 is a flow diagram illustrating process 700 for providing spelling corrections using an electronic device in accordance with some embodiments. Process 700 is described below with simultaneous reference to FIGS. 8, 9A-9B, 10, and 11. FIG. 8 illustrates an exemplary schematic block diagram of a language input module 800 in accordance with some embodiments. FIGS. 9A-9B illustrate an autocorrected sequence of Japanese words converted from a Japanese Romaji text input in accordance with some embodiments. FIGS. 10 and 11 illustrate electronic devices implementing aspects of lattice-based techniques for providing spelling corrections in accordance with some embodiments.

Process 700 is performed, for example, at an electronic device (e.g., 104, 200, 400, 600, 1000, or 1100 in FIG. 1, 2A, 4, 6A-6B, 10, or 11, respectively) with a display. In some examples, the electronic device can be a phone, laptop computer, desktop computer, tablet, wearable device (e.g., smart watch), speaker, set-top box, television, home automation device (e.g., thermostat), or any combination or subcombination thereof. In particular, process 700 can be performed using a language input module (e.g., language input module 800 of FIG. 8) implemented on the electronic device. In some examples, process 700 is performed using a client-server system (e.g., system 100), and the blocks of process 700 are divided up in any manner between the server and a client device. In other examples, the blocks of process 700 are divided up between the server and multiple client devices. Thus, while portions of process 700 are described herein as being performed by particular devices of a client-server system, it will be appreciated that process 700 is not so limited. In other examples, process 700 is performed using only a client device (e.g., user device 104) or only multiple client devices. In process 700, some blocks are, optionally, combined, the order of some blocks is, optionally, changed, and some blocks are, optionally, omitted. In some examples, additional steps may be performed in combination with the process 700.

At block 702, the electronic device receives a user input. The user input can be detected via any input devices of the electronic device, such as a touch-sensitive surface (e.g., touch screen displays and/or touchpads), a physical keyboard, a mouse, and/or a joystick. The user input can include a contact movement (e.g., taps, drags, scrolls), keyboard presses or holds, pen stylus input, mouse movement and mouse button presses, movement of the device, detected eye movements, and/or any combination thereof. For example, with reference to FIG. 10, an electronic device 1000 provides, via a touch-sensitive display 1008, a software keyboard 1002. The soft keyboard 1002 includes virtual or software buttons corresponding to a plurality of characters (e.g., “A”, “B”, “C”). In the depicted example, the electronic device 1000 detects multiple touch inputs (e.g., taps) on the software keyboard 1002.

At block 704, the electronic device obtains, based on the user input, a text string. In some examples, the user input includes a touch input (e.g., a tap) on a software keyboard of the electronic device, and the electronic device determines one or more candidate characters based on the contact area of the touch input and the layout of the software keyboard. In some examples, the electronic device further assigns a confidence score to each of the candidate characters based on the contact area of the touch input and the layout of the software keyboard. For example, if the contact area of the touch input overlaps with the soft button for the letter “A” and the soft button for the letter “S” in the software keyboard (e.g., software keyboard 1002), the electronic device identifies “A” and “S” as the candidate characters. Further, the electronic device can assign a higher confidence score to “A” than to “S” if, for example, the area of overlap between the contact area and the soft button “A” is larger than that between the contact area and the soft button “S” and/or if the location of the contact area is closer to the soft button “A” than to the soft button “S”.

In some examples, the user input includes multiple touch inputs and the electronic device determines one or more candidate characters for each of the touch inputs based on the layout of the software keyboard and the respective touch input. Accordingly, the electronic device obtains a plurality of candidate text strings and, in some examples, assigns confidence scores to the candidate text strings and ranks the candidate text strings accordingly. With reference to FIGS. 9A and 10, based on multiple touch inputs on the software keyboard 1002, the electronic device 1000 obtains a plurality of candidate text strings including a text string “ajkmsairteomdteouogzaikmsu”. The electronic device 1000 can assign a confidence score to each of the candidate characters in the text string “ajkmsairteomdteouogzaikmsu” and, based on the confidence scores of the candidate characters, assign a confidence score to the text string. In the depicted example, the text string “ajkmsairteomdteouogzaikmsu” has the highest confidence score and is processed further as shown in FIG. 9A.

The text string corresponds to a first symbolic system of a language and, in some examples, represents a phonetic pronunciation of at least part of a word of the language. The first symbolic system can be any phonetic symbolic writing system for transcribing a language. In one example, the first symbolic system comprises Chinese Pinyin or Chinese Zhuyin. In another example, the first symbolic system comprises Japanese Romaji. In the example depicted in FIGS. 9A-9B and 10, based on the user input (i.e., multiple touch inputs on the software keyboard 1002), the electronic device 1000 obtains a plurality of candidate text strings including the text string “ajkmsairteomdteouogzaikmsu” of the Japanese Romaji symbolic system. In this example, in response to receiving the user input, the electronic device 1000 displays a representation 1010 of the text string in user interface 1004.

In the example depicted in FIG. 11, the electronic device 1100 obtains a plurality of candidate text strings including the text string “nsihiwopenggyodezuiihaoderdn” of the Chinese Pinyin symbolic system. In this example, in response to receiving the user input (i.e., multiple touch inputs on the software keyboard 1102), the electronic device 1100 displays a representation 1110 of the text string in user interface 1104. In FIGS. 10 and 11, user interfaces 1004 and 1104 are user interfaces of a word processing program. It should be recognized that in other examples, the user interface can be any text-based user interface of an application, such as a messaging application, email application, web browser, or the like.

At block 706, the electronic device determines, based on the text string, a plurality of character segments. In some examples, at least one character segment of the plurality of character segments corresponds to a syllable in the language. In some examples, the electronic device identifies character segments based on one or more rules specific to the language. The language-specific rules can specify, for example, one or more valid combinations of characters in the first symbolic system of the language. For example, the Chinese-specific rules may specify single characters and/or character combinations that correspond to valid spellings of syllables in Chinese (e.g., “a”, “wo”, “ni”, “ku”). As another example, the Japanese-specific rules may specify single characters and/or character combinations that correspond to valid portions of Romaji inputs (e.g., “ma”, “da”, “mas”, “tte”, “toe”). With reference to FIG. 9A, based on the text string “ajkmsairteomdteouogzaikmsu” and the Japanese-specific rules, the electronic device identifies a plurality of character segments (each marked by a square in FIG. 9A) such as “a”, “sa”, “j a”, “ka”, “mas”, “det”, “zia”.

In some examples, the one or more language rules are part of a language input module of the electronic device. FIG. 8 illustrates an exemplary schematic block diagram of language input module 800 in accordance with some embodiments. Specifically, language input module 800 enables a multifunctional device (e.g., 1000 and 1100) to perform processes for providing spelling corrections (e.g. process 700) as described herein. In some examples, language input module 800 is implemented using one or more multifunctional devices including but not limited to devices (e.g., 104, 200, 400, 600, 1000, or 1100 in FIG. 1, 2A, 4, 6A-6B, 10, or 11, respectively). In particular, memory 202 (FIG. 2A) or 470 (FIG. 4), in some examples, includes language module 800. As shown in FIG. 8, language input module 800 includes language input converter engine 802, dictionary 804, language models 808, lexicon 806, vocabulary store 810, and language-specific rules 812. Language input converter module 802 is configured to receive text of a first symbolic system and to convert the text to candidate words of a second symbolic system. In particular, language input converter module 802 is configured to receive text of the first symbolic system and parse it into one or more character segments based on, for example, language-specific rules 812. Exemplary uses of the other components of the language input module 800 are described below.

In some examples, the electronic device determines the plurality of character segments based on context information. For example, based on previous user inputs and/or one or more settings of the electronic device, the electronic device can determine an input method (e.g., Jianpin, Shuangpin) associated with the user input. In some examples, based on the determined input method, the electronic device can generate the plurality of character segments in accordance with language rules corresponding to the determined input method. In some examples, based on the determined input method, the electronic device can forego determining the plurality of character segments.

In some examples, at least one character segment of the plurality of character segments comprises one or more characters. The one or more characters can include one or more letters, one or more numbers, one or more symbols, one or more carriage returns, one or more spaces, or any combination thereof. With reference to FIG. 9A, one exemplary character segment “ki” includes two letters “k” and “i”. In some examples, the one or more characters do not include a letter, a number, or a symbol. With reference to FIG. 9A, one exemplary character segment “0” represents a null.

Among the plurality of character segments, a first character segment and a second character segment correspond to a same portion of the text string. With reference to FIG. 9A, all of the character segments arranged in the same column (e.g., “ø”, “ka”, “ki”, “ku”, “ke”, “ko”, “i” in Column 3) correspond to the text portion “k” of the text string “ajkmsairteomdteouogzaikmsu”. In some examples, two character segments correspond to the same portion of the text string if at least portions of the two character segments correspond to the same portion of the text string. With reference to FIG. 9A, character segments “te”, “t”, “e”, “tte”, “toe”, “ote”, “ret” in Column 8 all correspond to the text portion “te” of the text string “ajkmsairteomdteouogzaikmsu”.

In some examples, the electronic device provides one or more associations among the identified character segments. For example, the electronic device may associate a character segment (e.g., “ja” in Column 2) with another character segment (e.g., “ki” in Column 3) if the two character segments correspond to adjacent portions of the text string (“j” and “k”), respectively. In the depicted example in FIG. 9A, the character segment “ki” in Column 3 is associated with each of the character segments arranged in the adjacent columns, that is, character segments “ø”, “ja”, “ji”, “ju”, “je”, “jo”, “u”, and “ja” in Column 2 and character segments “ø”, “ma”, “mi”, “mu”, “me”, “mo”, “n”, and “mas” in Column 4. Further, the character segment “ki” may be further associated with “sa” in the Column 5 because Column 4 includes a null segment “ø”. Accordingly, the electronic device creates a “lattice” of interconnected character segments based on the text string “ajkmsairteomdteouogzaikmsu”.

At least one of the first character segment and the second character segment is a modified version of the portion of the text string. In some examples, the modified version can include the original portion with additional characters, with fewer characters, with one or more characters replaced, with the same characters arranged in a different order, or any combination thereof. In the example depicted in FIG. 9A, character segments “ki” and “ke” in Column 3 both correspond to, and are modified versions of, text portion “k”. As another example, character segments “t”, “e”, “tte”, “toe”, “ote”, “ret” in Column 8 are all modified versions of the text portion “te”. In particular, the character segment “toe” can be considered as a modified version of the text portion “te”, the text portion “teo”, and/or the text portion “o”, in some examples.

It should be appreciated that a character segment that is a modified version of a text portion represents an auto-corrected version of the text portion. For example, the character segment “i” corresponding to text string portion “k” (Column 3) represents an auto-correction of a substitution error (i.e., the user entered the wrong character). As another example, the character segment “t” corresponding to text string portion “te” represents an auto-correction of an insertion error (i.e., the user inserted a character “e” by mistake). As another example, the character “tte” corresponding to text string portion “te” represents an auto-correction of a deletion error (i.e., the user did not enter a character “t” by mistake). As yet another example, the character segment “toe” corresponding to text string portion “teo” represents an auto-correction of a transposition error (i.e., the user entered “e” and “o” in the wrong order).

In some examples, the electronic device identifies a set of character segments (e.g., based on one or more rules specific to the language) and further identifies, from the set of character segments, a subset of the set of character segments for further processing. In some examples, the electronic device calculates a confidence score corresponding to a particular character segment of the set of character segments and determines whether to include the particular character segment in the subset based on the confidence score. The confidence score of the particular character segment (e.g., “ki”) can be calculated based on one or more language models, one or more common error patterns, one or more grammatical rules, information related to the corresponding user input (e.g., contact area of the touch inputs “k” and “i”), the type/layout of the corresponding keyboard (e.g., soft keyboard 1002), or any combination thereof, as discussed below.

For example, the electronic device can calculate a confidence score for a particular character segment based on a language model (e.g., part of language models 808). The language model can be trained using a corpus of text (e.g., Romaji inputs, Pinyin inputs) and can include one or more statistical language models (e.g., n-gram language models, neural network based language models). In some examples, the electronic device provides the set of character segments to the language model and obtains from the language model confidence scores corresponding to the character segments. In some examples, the electronic device also obtains confidence scores corresponding to the associations among the character segments.

As another example, the electronic device can calculate a confidence score for a particular character segment based on one or more predefined character sequences. The predefined character sequences can correspond to common error patterns. In some examples, the electronic device compares each of the set of character segments to the common error patterns and obtains corresponding confidence scores (e.g., based on the degree of matching between a common error pattern and a respective character segment). In some examples, the electronic device compares combinations of associated character segments (e.g., “ja” followed by “ki”) to the common error patterns and obtains corresponding confidence scores (e.g., based on the degree of matching between a common error pattern and a respective combination). In some examples, the electronic device also obtains confidence scores corresponding to the associations among the character segments based on the common error patterns. For example, if a common error pattern is “jaki”, the electronic device may assign a low confidence score to character segment “ja”, character segment “ki”, and/or the association between “ja” and “ki” in the lattice.

As another example, the electronic device can calculate a confidence score for a particular character segment based on information related to the corresponding user inputs. In some examples, the electronic device calculates a confidence score for a character segment (e.g., “ki”) based on the confidence scores associated with one or more characters in the character segment (e.g., “k” and “i”), which in turn can be based on the contact areas of the two touch inputs.

As yet another example, the electronic device can calculate a confidence score for the particular character segment based on a type of the keyboard of the electronic device. For example, if a particular type of error is known to be common for the keyboard of the electronic device, the electronic device can assign a higher confidence score to a character segment corresponding to a correction of the particular type of error. For example, if the electronic device detects a user input via a software keyboard and transposition errors (i.e., pressing the keys in the wrong order) are known to be common for software keyboards, the electronic device may assign a character segment “toe” (corresponding to a correction from “teo”) a higher confidence score. As another example, if the electronic device detects a user input via a hardware keyboard and deletion errors (i.e., missing pressing a key) is known to be common for hardware keyboards, the electronic may assign a character segment “sa” (corresponding to a correction from “s”) a higher confidence score.

In some examples, the electronic device aggregates any combination of the above-discussed confidence scores for the particular character segment (and optionally, for any association related to the character segment) and determines whether the aggregated confidence score exceeds a predefined threshold. In accordance with a determination that the confidence score exceeds the predefined threshold, the electronic device includes the particular character segment in the subset. In accordance with a determination that the confidence score does not exceed the predefined threshold, the electronic device foregoes including the particular character segment in the subset. In some examples, the subset of character segments includes one or more associations (e.g., and corresponding confidence scores) among the character segments in the subset.

At block 708, the electronic device determines, based on the plurality of character segments, a plurality of sequences of candidate words in a second symbolic system of the language. In some examples, the plurality of character segments is the subset of the set of character segments identified by the electronic device as described above. In some examples, the electronic device first compares the plurality of character segments with words in one or more predefined lexicons (e.g., lexicon 806) to obtain a plurality of candidate words of the second symbolic system. The one or more lexicons include a collection of words or strings of the first symbolic system that each correspond to one or more words of the second symbolic system. For example, a lexicon can include a collection of Chinese Pinyin words or strings that each correspond to one or more Chinese characters/words. As another example, a lexicon can include a collection of Japanese Romaji words or strings that each correspond to one or more Japanese words (e.g., in Kanji or Hiragana). In some examples, the one or more lexicons can be adapted based on user-specific information. In some examples, the electronic device further obtains one or more associations among the plurality of candidate words.

With reference to FIG. 9B, the electronic device obtains a plurality of Japanese words such as “ [symbol] ” (akimasa), “ [symbol] ” (aki), “ [symbol] ” (akemasite), “ [symbol] ” (medetou), and “ [symbol] ” (masu), based on the lattice of character segments depicted in FIG. 9A. Further, two candidate words corresponding to adjacent character segments can be associated with each other in a manner consistent with what is described above with respect to the lattice of character segments. For example, the character segment “ [symbol] ” (aki) is associated with each of the character segments “ [symbol] ,” (misairu), “ [symbol] ” (mi), “ [symbol] ” (masite), and “ [symbol] ” (masi). Accordingly, based on the lattice of character segments, the electronic device obtains a lattice of candidate words.

In some examples, the electronic device obtains the plurality of sequences of candidate words based on the lattice of candidate words. A sequence of candidate words can include a series of candidate words joined by associations in the lattice of candidate words. With reference to FIG. 9B, a sequence of candidate words can start with “ [symbol] (aki), [symbol] (misairu)”, another sequence of candidate words can start with “ [symbol] ” (akimasa), and yet another sequence of candidate words can start with “ [symbol] ” (akemasite). The plurality of sequences of candidate words include a first sequence of candidate words based on the first character segment and a second sequence of candidate words based on the second character segment. Among the three sequences discussed above, the first two sequences of candidate words are based on character segment “ki” (first character segment), while the third sequence of candidate words is based on character segment “ke” (second character segment). As shown in the lattice of character segments in FIG. 9A, both character segments “ki” and “ke” correspond to the same portion of text string “k” and are modified versions of “k” (Column 3).

In some examples, a single candidate word corresponds to multiple character segments, which in turn correspond to multiple portions of the text string. With reference to FIG. 9A, the text string portion “k” is a first portion of the text string and the text string portion “m” is a second portion of the text string. Further, the first character segment “ki” and the second character segment “ke” both correspond to “k” (Column 3), while a third character segment “ma” and a fourth character segment “mi” both correspond to “m” (Column 4). The electronic device can identify a first candidate word of a first sequence of candidate words based on the first character segment (“ki”) and the third character segment (“ma”). Further, the electronic device can identify a second candidate word of a second sequence of candidate words based on the second character segment (e.g., “ke”) and the fourth character segment (“mi”).

In some examples, the electronic device calculates a plurality of confidence scores corresponding to the plurality of candidate words. For example, the electronic device can calculate a confidence score for each candidate word. In some examples, the confidence score of a candidate word is calculated based on the confidence scores of the corresponding character segments. In some examples, the confidence score of a candidate word is calculated based on user-specific information (e.g., higher confidence score is given to a word frequently used by the user). In some examples, the confidence score of a candidate word is calculated based on one or more language models (e.g., part of language models 808), one or more common error patterns, one or more grammatical rules, information related to the corresponding user inputs, the type/layout of the corresponding keyboard, or any combination thereof, in a manner consistent with what is discussed above with respect to calculating a candidate score for a character segment.

At block 710, the electronic device identifies a sequence of the plurality of sequences of candidate words. In some examples, the electronic device determines a plurality of confidence scores corresponding to the plurality of sequences of candidate words. For each sequence of candidate words, the electronic device can determine a confidence score, for example, based a language model (e.g., part of language models 808). For example, a language model determines each confidence score given the textual context where the respective sequence appears. The language model is, for example, a statistical language model, such as an n-gram language model, or a neural network based language model, such as a recurrent neural network language model (RNNLM) or a long short-term memory language model (LSTMLM). The language model is configured to receive a sequence of candidate words and determine a corresponding confidence score. The confidence score represents, for example, the likelihood of occurrence of the sequence of candidate words in a corpus of text used to train the language model. In some examples, the language model is adapted based on user-specific information. Additionally or alternatively, the electronic device determines a confidence score of a sequence of candidate words based on the confidence scores of the corresponding candidate words, which are in turn based on, for example, other language models and layout of the corresponding keyboard, as discussed above. Additional description of the identification of a sequence of candidate words and the use of a language input module can be found in U.S. Provisional Patent Application No. 62/348,664, “DYNAMIC PHRASE EXPANSION OF LANGUAGE INPUT,” filed Jun. 10, 2016, the contents of which is hereby incorporated by reference in its entirety.

In some examples, the electronic device ranks the plurality of sequences of candidate words based on the plurality of confidence scores (e.g., from the highest confidence score to the lowest). In some examples, the electronic device identifies the sequence of candidate words having the highest confidence score. With reference to FIG. 9B, the sequence of candidate words “ [symbol] ” (akemasite), “ [symbol] ” (o), “ [symbol] ” (medetou), “ [symbol] ” (gozai), “ [symbol] ” (masu) is the most semantically correct and thus the most likely to occur in a corpus of text among the plurality of candidate sequences. Therefore, in this example, this particular sequence is determined to have the highest likelihood score among the plurality of sequences of candidate words.

At block 712, the electronic device displays the identified sequence of candidate words for user selection. With reference to FIG. 10, the electronic device 1000 displays the identified sequence 1058 “ [symbol] [symbol] ” as an auto-correct suggestion on the touch-sensitive display 1004. With reference to FIG. 11, the electronic device 1100 displays the identified sequence 1158 “ [symbol] [symbol] ” as an auto-correct suggestion on the touch-sensitive display 1104.

It should be appreciated that the exemplary process described above with respect to FIG. 7 can be performed to provide spelling corrections for user inputs in any conversion-based languages (e.g., Chinese, Japanese). It should be further appreciated that the electronic device can obtain any number of lattices at any granularity (e.g., lattices of characters, lattices of character segments, lattices of words, lattices of phrases, lattices of sentences). For example, the exemplary process 700 is described above with respect to a text string “ajkmsairteomdteouogzaikmsu”. However, the electronic device may obtain a plurality of text strings arranged in a character lattice, and obtain lattices of lower granularity (e.g., character segments, words) accordingly. It should be further appreciated that the lattice-based techniques allow the electronic device to correct multiple errors even if all of the errors are located close to each other in the text string (e.g., correcting “ajkmsairteomdteouogzaikmsu” to “akemasiteomedetougozaimasu”).

The operations described above with reference to FIG. 7 are optionally implemented by components depicted in FIGS. 1-4 and 6A-6B. For example, the operations of process 700 may be implemented by any device (or component thereof) described herein, including but not limited to, devices 104, 200, 400, 600, 1000, and 1100. It would be clear to a person having ordinary skill in the art how other processes are implemented based on the components depicted in FIGS. 1-4 and 6A-6B.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A non-transitory computer-readable storage medium storing one or more programs, the one or more programs comprising instructions, which when executed by one or more processors of an electronic device, cause the electronic device to:
receive a user input;
obtain, based on the user input, a text string corresponding to a first symbolic system of a language;
determine, based on the text string, a plurality of character segments,
wherein a first character segment and a second character segment of the plurality of character segments correspond to a same portion of the text string; and
wherein at least one of the first character segment and the second character segment is a modified version of the portion of the text string;
determine, based on the plurality of character segments, a plurality of sequences of candidate words in a second symbolic system of the language, wherein the plurality of sequences of candidate words comprises a first sequence of candidate words based on the first character segment and a second sequence of candidate words based on the second character segment;
identify a sequence of the plurality of sequences of candidate words; and
display the identified sequence of candidate words for user selection.

2. The non-transitory computer-readable storage medium of claim 1, wherein at least one character segment of the plurality of character segments comprises one or more characters.

3. The non-transitory computer-readable storage medium of claim 2, wherein the one or more characters include one or more letters, one or more numbers, one or more symbols, one or more carriage returns, one or more spaces, or any combination thereof.

4. The non-transitory computer-readable storage medium of claim 3, wherein the one or more characters do not include a letter, a number, or a symbol.

5. The non-transitory computer-readable storage medium of claim 1, wherein at least one character segment of the plurality of character segments corresponds to a syllable in the language.

6. The non-transitory computer-readable storage medium of claim 1, wherein determining the plurality of character segments comprises identifying a set of character segments based on one or more rules specific to the language.

7. The non-transitory computer-readable storage medium of claim 6, wherein the one or more rules specify one or more valid combinations of characters in the first symbolic system of the language.

8. The non-transitory computer-readable storage medium of claim 6, wherein determining the plurality of character segments further comprises providing one or more associations among the identified set of character segments.

9. The non-transitory computer-readable storage medium of claim 6, wherein determining the plurality of character segments further comprises:
identifying, from the set of character segments, a subset of the set of character segments, wherein the subset of the set of character segments is the plurality of character segments.

10. The non-transitory computer-readable storage medium of claim 9, wherein identifying the subset of the set of character segments comprises identifying the subset of the set of character segments based on a language model.

11. The non-transitory computer-readable storage medium of claim 9, wherein identifying the subset of the set of character segments comprises identifying the subset based on one or more predefined character sequences.

12. The non-transitory computer-readable storage medium of claim 9, wherein identifying the subset of the set of character segments comprises:
calculating a confidence score corresponding to a particular character segment of the set of character segments; and
determining whether to include the particular character segment in the subset based on the confidence score.

13. The non-transitory computer-readable storage medium of claim 12, wherein determining whether to include the particular character segment in the subset based on the confidence score comprises: determining whether the confidence score exceeds a predefined threshold, and wherein the one or more programs further comprise instructions, which when executed by one or more processors of the electronic device, cause the electronic device to:
in accordance with a determination that the confidence score exceeds the predefined threshold, include the particular character segment in the subset;
in accordance with a determination that the confidence score does not exceed the predefined threshold, forgo including the particular character segment in the subset.

14. The non-transitory computer-readable storage medium of claim 1, wherein determining the plurality of sequences of candidate words comprises: obtaining, based on the plurality of character segments, a plurality of candidate words and one or more associations among the plurality of candidate words.

15. The non-transitory computer-readable storage medium of claim 14, wherein obtaining the plurality of candidate words comprises comparing at least one character segment of the plurality of character segments with words in one or more predefined lexicons.

16. The non-transitory computer-readable storage medium of claim 14, further comprising instructions, which when executed by one or more processors of the electronic device, cause the electronic device to: calculate a plurality of confidence scores corresponding to the plurality of candidate words.

17. The non-transitory computer-readable storage medium of claim 14,
wherein the portion of the text string is a first portion of the text string,
wherein the plurality of character segments comprises a third character segment and a fourth character segment,
wherein the third character segment and the fourth character segment correspond to a second portion of the text string, and wherein the one or more programs further comprise instructions, which when executed by one or more processors of the electronic device, cause the electronic device to:
identify a first candidate word of the first sequence of candidate words based on the first character segment and the third character segment; and
identify a second candidate word of the second sequence of candidate words based on the second character segment and the fourth character segment.

18. The non-transitory computer-readable storage medium of claim 1, further comprising instructions, which when executed by one or more processors of the electronic device, cause the electronic device to:
determine a plurality of confidence scores corresponding to the plurality of sequences of candidate words;
rank the plurality of sequences of candidate words based on the plurality of confidence scores.

19. The non-transitory computer-readable storage medium of claim 1, wherein determining the plurality of character segments comprises determining the plurality of character segments based on context information.

20. The non-transitory computer-readable storage medium of claim 1, further comprising instructions, which when executed by one or more processors of the electronic device, cause the electronic device to:
display a software keyboard on a touch-screen of the electronic device,
wherein receiving the user input comprises detecting, via the touch-screen, one or more touch inputs, and
wherein obtaining the text string comprises determining, for each of the one or more touch inputs, one or more characters based on a layout of the displayed software keyboard.

21. The non-transitory computer-readable storage medium of claim 20, wherein determining the plurality of character segments comprises determining the plurality of character segments based on the layout of the displayed software keyboard.

22. The non-transitory computer-readable storage medium of claim 1, wherein obtaining the text string comprises obtaining a plurality of candidate text strings, and wherein the text string is one of the plurality of candidate text strings.

23. The non-transitory computer-readable storage medium of claim 1, wherein the text string corresponding to the first symbolic system of the language represents a phonetic pronunciation of at least part of a word of the language.

24. The non-transitory computer-readable storage medium of claim 1, wherein the electronic device is a computer, a set-top box, a speaker, a smart watch, a phone, or any combination thereof.

25. An electronic device, comprising:
one or more processors;
a memory; and
one or more programs, wherein the one or more programs are stored in the memory and configured to be executed by the one or more processors, the one or more programs including instructions for:
receiving a user input;
obtaining, based on the user input, a text string corresponding to a first symbolic system of a language;
determining, based on the text string, a plurality of character segments,
wherein a first character segment and a second character segment of the plurality of character segments correspond to a same portion of the text string; and
wherein at least one of the first character segment and the second character segment is a modified version of the portion of the text string;
determining, based on the plurality of character segments, a plurality of sequences of candidate words in a second symbolic system of the language, wherein the plurality of sequences of candidate words comprises a first sequence of candidate words based on the first character segment and a second sequence of candidate words based on the second character segment;
identifying a sequence of the plurality of sequences of candidate words; and
displaying the identified sequence of candidate words for user selection.

26. A method comprising:
at an electronic device with one or more processors and memory:
receiving a user input;
obtaining, based on the user input, a text string corresponding to a first symbolic system of a language;
determining, based on the text string, a plurality of character segments,
wherein a first character segment and a second character segment of the plurality of character segments correspond to a same portion of the text string; and
wherein at least one of the first character segment and the second character segment is a modified version of the portion of the text string;
determining, based on the plurality of character segments, a plurality of sequences of candidate words in a second symbolic system of the language, wherein the plurality of sequences of candidate words comprises a first sequence of candidate words based on the first character segment and a second sequence of candidate words based on the second character segment;
identifying a sequence of the plurality of sequences of candidate words; and
displaying the identified sequence of candidate words for user selection.
